(19) United States
(12) Patent Application Publication
(10) Pub. No.: US 2014/0307213 A1
(43) Pub. Date: Oct. 16, 2014

(54) DISPLAY DEVICE

(71) Applicant: Japan Display Inc., Tokyo (JP)

(72) Inventors: Tomohiko NAGANUMA, Tokyo (JP); Shinichiro OKA, Tokyo (JP)

(73) Assignee: Japan Display Inc., Tokyo (JP)

(21) Appl. No.: 14/244,147

(22) Filed: Apr. 3, 2014

(30) Foreign Application Priority Data
Apr. 11, 2013 (JP) 2013-083285

(51) Int. Cl. G02F 1/1343

(52) U.S. Cl. CPC G02F 1/1343
USPC 349/139

(57) ABSTRACT

In a three-dimensional display device employing liquid crystal lenses, the crosstalk caused by disclination occurring in the liquid crystal lenses is prevented. The liquid crystal lens includes a liquid crystal of the TN type having a twist angle of 90 degrees, the liquid crystal being sandwiched between a first substrate and a second substrate. A first electrode in a flat shape is formed on the first substrate to substantially cover the first substrate. Second electrodes shaped like comb teeth are formed on the second substrate. Each of the second electrodes is formed on the top of a projection formed on the second substrate. Three-dimensional display is performed by applying voltage between the first and second electrodes. The second electrode may be formed also on side faces of the projection. With this configuration, a three-dimensional image display device with less crosstalk can be realized.

### CLAIM OF PRIORITY

The present application claims priority from Japanese Patent Application JP 2013-83285 filed on Apr. 11, 2013, the content of which is hereby incorporated by reference into this application.

### BACKGROUND OF THE INVENTION

1. Field of the Invention

The present invention relates to a display device. More specifically, the invention relates to a three-dimensional display device of the type comprising liquid crystal lenses (having the lens function) arranged on the display surface's side of the liquid crystal display panel.

2. Description of the Related Art

There is a display device capable of switching between the three-dimensional (3D) display and the two-dimensional (2D) display for the naked eyes without needing eyeglasses or the like. For example, Such a display device includes a first liquid crystal display panel for performing the image display and a second liquid crystal display panel arranged on the display surface's side (viewer's side) of the first liquid crystal display panel to form the parallax barriers for making separate rays of light enter the right and left eyes of the viewer at the time of 3D display. The liquid crystal display device thus switchable between 2D display and 3D display is configured to distribute rays of light of pixels corresponding to the right and left eyes to the viewpoint (right and left eyes) of the viewer by forming lens (lenticular lens, cylindrical lens array) areas extending in the vertical direction of the display surface and arranged repeatedly in the horizontal direction of the display surface. The lens areas extending in the vertical direction and arranged in the horizontal direction are formed by controlling the orientations of liquid crystal molecules inside the second liquid crystal display panel to change the refractive index of each part inside the second liquid crystal display panel.

An automatic stereoscopic display device described in JP-A-2009-520231 can be taken as an example of such a three-dimensional display device of the liquid crystal lens type configured as above. In the display device of JP-A-2009-520231, a planar electrode is formed on one of transparent substrates arranged to face each other across a liquid crystal layer, while strip-shaped electrodes (linear electrodes) extending in the direction of formation of each lens are formed on the other transparent substrate. The linear electrodes are arranged repeatedly in the direction of arrangement of the lenses. This configuration permits the switching between 2D display and 3D display to be controlled by controlling the voltages applied to the planar electrode and the strip-shaped electrodes so that the refractive indices of the liquid crystal molecules may be controlled. TN-oriented liquid crystal lenses are employed as the liquid crystal lenses in the display device of JP-A-2009-520231.

Japanese Patent No. 2862462 describes a configuration for forming a three-dimensional image by controlling lens properties. A variable optical property lens sandwiched between electrodes (a planer electrode and strip-shaped electrodes) is arranged on the liquid crystal display panel. The lens properties of the variable optical property lens is controlled for the three-dimensional image display by applying appropriate voltages between the planer electrode and the strip-shaped electrodes sandwiching the variable optical property lens.

### SUMMARY OF THE INVENTION

FIG. 14 is a cross-sectional view showing the configuration of a conventional liquid crystal lens. In FIG. 14, a first electrode 11 in a flat shape is formed inside a first substrate 10 (used as a transparent substrate) to substantially cover the first substrate 10, and a first alignment layer 12 is formed on the first electrode 11. Inside a second substrate 20 used as another transparent substrate, second electrodes 21 in strip-like shapes (like the teeth of a comb) are formed, and a second alignment layer 22 is formed to cover the second electrodes 21. The direction of orientation (orientation direction) of the second alignment layer 22 is the same as that of the first alignment layer 12. The first and second substrates 10 and 20 are desired to be glass substrates; however, the substrates 10 and 20 may also be transparent plastic substrates. A liquid crystal layer 60 is sandwiched between the first alignment layer 12 and the second alignment layer 22.

The electrode width of each comb-tooth electrode formed on the second substrate 20 is w2. The inter-electrode pitch of the comb-tooth electrodes is Q. The distance between adjacent comb-tooth electrodes is S. The distance between the first alignment layer 12 and the second alignment layer 22 (i.e., liquid crystal layer thickness) is d1. The liquid crystal has positive dielectric anisotropy. In a three-dimensional image display device employing such liquid crystal lenses, the three-dimensional image display is possible by applying voltage between the first and second electrodes 11 and 21. The two-dimensional image display is possible by applying no voltage between the first and second electrodes 11 and 21.

FIG. 15 is a cross-sectional view showing the principle of the formation of a three-dimensional image by using the liquid crystal lenses. Referring to FIG. 15, the human eyes visually recognize the image formed on the display device through the liquid crystal lenses. In FIG. 15, the reference characters “R” represent images for the right eye, while the reference characters “L” represent images for the left eye. The pitch (interval) of the liquid crystal lenses 100 is Q and the pitch (interval) of the pixels of the display device 200 is P in FIG. 15. The distance between the centers of the right and left eyes of the human (i.e., inter-eye distance) is represented as B. The inter-eye distance B is generally assumed to be 65 mm. The relationship among the liquid crystal lens pitch Q, the display device pixel pitch P and the inter-eye distance B is represented by the following expression (1):

$$\begin{matrix}〈 Expression 1 〉 & \\ Q = \frac{2 P}{( 1 + P / B )} & ( 1 )\end{matrix}$$

FIG. 16 is a cross-sectional schematic diagram of a three-dimensional image display device employing a liquid crystal lens 100 (liquid crystal lenses) targeted by the present invention. In FIG. 16, the liquid crystal lens 100 and a display device 200 are bonded together by using an adhesive material 300. The adhesive material 300 is transparent (e.g., UV (ultraviolet) curable resin). A liquid crystal display device, an organic EL display device or the like is used as the display device 200.

FIGS. 17A and 17B are plan views of the liquid crystal lens 100 corresponding to the line B-B′ in FIG. 16. In FIG. 17A, the first substrate 10 is covered with the first electrode 11 throughout the display area. In FIG. 17B, the comb-tooth second electrodes 21 are formed on the second substrate 20. The second electrodes 21 are connected together at one ends by a bus electrode. Incidentally, FIG. 14 is a cross-sectional view corresponding to the A-A′ cross section in FIG. 17B.

FIGS. 18A-18C are cross-sectional views showing the principle of the liquid crystal lens. Application of voltage between the first and second electrodes 11 and 21 causes lines F of electric force as shown in FIG. 18A. When no voltage is applied between the first and second electrodes 11 and 21, the liquid crystals are oriented horizontally as shown in FIG. 18B. Incidentally, the pretilt angle is ignored in the drawings in this application in order to avoid complexity.

When voltage is applied between the first and second electrodes 11 and 21, the liquid crystal molecules 61 over the second electrodes 21 are oriented upright as shown in FIG. 18C. About the middle between the comb-tooth electrodes, the liquid crystal molecules 61 are substantially oriented horizontally. Such orientation of the liquid crystal molecules 61 causes a certain distribution of the refractive index (refractive index distribution) in the liquid crystal layer, implementing a refractive index distribution-type lens (GRIN (gradient index) lens).

Conventional liquid crystal lenses of the ordinary type are configured as shown in FIGS. 14-18C. The liquid crystal lenses configured as above involves the following problems: Since the disclination occurs in regions over the comb-tooth electrodes, the incident light is scattered in the regions over the electrodes and that increases the crosstalk. The “disclination” means discontinuity lines deriving from the arrangement of the liquid crystal molecules. The “crosstalk” means insufficiency of the separation between the image for the right eye and the image for the left eye. Incidentally, when the crosstalk is high, the image displayed by the display device is visually recognized not as a three-dimensional image but just as two overlapped images.

On the other hand, the configuration shown in FIGS. 19A and 19B has the possibility of reducing the disclination and the crosstalk. In FIGS. 19A and 19B, the orientation of the liquid crystal molecules in the liquid crystal lens is implemented as the TN orientation and a polarizing plate 13 is arranged on one side of the first substrate 10 opposite to the liquid crystal layer. At this point, the TN liquid crystal molecules in the liquid crystal layer are in the twisted orientation (twisted alignment) of approximately 90 degrees. In other words, the orientation direction of a first alignment layer (unshown) formed on the first substrate 10 and the orientation direction of a second alignment layer (unshown) formed on the second substrate 20 differ from each other by 90 degrees in FIG. 19A. The mechanism of such a liquid crystal lens will be explained below.

FIG. 19A shows a state in which no voltage is applied between the first and second electrodes 11 and 21. In this case, the image from the display device is not at all influenced by the liquid crystal lens. FIG. 19B shows a state in which voltage is applied between the first and second electrodes 11 and 21. Between the adjacent comb-tooth electrodes (second electrodes 21), the liquid crystal molecules are oriented so as to form a lens. In contrast, in the regions over the second electrodes 21, the lines F of electric force extend orthogonally to the second electrodes 21, and thus the liquid crystal molecules 61 are also oriented orthogonally to the second electrodes 21 (vertical alignment). Thus, the light from the display device does not pass through these regions. Consequently, the crosstalk can be prevented.

It is desirable in FIGS. 19A-19B that the transmission axis of the polarizing plate 13 is at approximately 90 degrees from the polarization direction of the light emitted from the display device. In cases where the display device is a liquid crystal display device, the light emitted from the display device is already polarized light. In cases where the display device is an organic EL display device, it is necessary to attach a polarizing plate to the surface of the organic EL display device.

This mechanism will be explained in more detail referring to FIG. 20. FIG. 20 is a cross-sectional view showing the polarization direction of the incident light, the polarization direction of the outgoing light, and the transmission axis of the first polarizing plate 13 when no voltage is applied between the first and second electrodes 11 and 21. In the case of a liquid crystal lens that is initially in the TN orientation, the incident polarized light is rotated by 90 degrees in the liquid crystal layer when no voltage is applied between the first and second electrodes 11 and 21 (FIG. 20). Thus, assuming that the polarization direction of the incident light is the X-axis direction, the polarization direction of the outgoing light is the Y-axis direction. On the assumption that the polarized light transmission axis PA of the first polarizing plate 13 is in the Y direction, the incident light passes through the liquid crystal lens. As above, in the two-dimensional display in which no voltage is applied between the first and second electrodes 11 and 21, the liquid crystal lens exerts no influence on the light emitted from the display device.

In contrast, when voltage is applied to the TN-oriented liquid crystal lens, the liquid crystal molecules 61 are oriented as shown in FIG. 19B. As is clear from FIG. 19B, the optical rotatory power is lost in the regions over the second electrodes 21 since the liquid crystal molecules 61 are oriented vertically (upright) in the regions. However, in the vicinity of the central part between adjacent second electrodes 21 (comb-tooth electrodes), the orientation of the liquid crystal molecules 61 remains almost the same as the initial orientation, and thus the optical rotatory power is caused and the polarization axis of the incident light is rotated by 90 degrees. As a result, the light passes through the region between the adjacent second electrodes 21 although the light is blocked in the regions over the second electrodes 21. Although the conventional liquid crystal lenses involve the problem of the crosstalk increased by the scattering of light caused by the disclination occurring in the regions over the second electrodes 21, there is a possibility that the problem can be resolved by employing the configuration shown in FIG. 19B.

In consideration of the above-described situation, the present inventors created a TN-oriented liquid crystal lens according to the following parameters:

liquid crystal physical property value Δn: 0.2

liquid crystal gap d1: 30 μm

panel size: 3.2″

number of pixels: 480×854

pixel pitch P: 79.5 μm

lens pitch Q: 158.8058 μm

electrode width w2: 10 μm

However, we found that a sufficient vertical electric field does not develop in this liquid crystal lens since the electric field extends also in the in-plane direction of the substrates due to the high ratio (d1/w2=3) between the liquid crystal gap d1 and the electrode width w2. Therefore, the light-blocking effect in the regions over the second electrodes 21 is not achieved sufficiently with this configuration.

FIGS. 22A and 22B are graphs showing examples of the transmittance distribution in TN-orientated liquid crystal lenses, wherein the horizontal axis represents the position and the vertical axis represents the transmittance. In the ideal transmittance distribution shown in FIG. 22A, the transmittance decreases to substantially 0 in the vicinity of the second electrodes 21. In actual samples, however, the transmittance does not decrease sufficiently in the vicinity of the second electrodes 21 as shown in FIG. 22B for the aforementioned reasons, and consequently, the intended light-blocking effect is not achieved.

Incidentally, in standard liquid crystal display devices of the TN type, the liquid crystal gap is approximately 4 μm while the electrode width is tens to hundreds of microns, that is, the ratio between the liquid crystal gap and the electrode width is extremely small.

The object of the present invention, which has been made in consideration of the above-described situation, is to sufficiently reduce the transmittance in the regions over the second electrodes in the TN-orientated liquid crystal lenses, prevent the occurrence of the disclination, and thereby prevent the crosstalk of the display device employing the TN-orientated liquid crystal lenses.

Principal means according to the present invention for achieving the above object are as follows:

(1) A display device comprising a display panel and liquid crystal lenses arranged on the display panel, wherein the liquid crystal lens includes a liquid crystal of the TN type having a twist angle of 90 degrees, the liquid crystal being sandwiched between a first substrate and a second substrate, a first electrode in a flat shape is formed on the liquid crystal's side of the first substrate to substantially cover the first substrate, second electrodes in a shape like comb teeth in the plan view are formed on the liquid crystal's side of the second substrate, each of the second electrodes is formed on the top of a projection formed on the second substrate, three-dimensional display is performed by applying voltage between the first and second electrodes, and two-dimensional display is performed by applying no voltage between the first and second electrodes.

(2) The display device according to item (1), wherein the second electrode is formed also on side faces of the projection.

(3) The display device according to item (1), wherein the projection has a cross-sectional shape like a curved line.

(4) The display device according to item (1), wherein the height of the projection is greater than or equal to 0.8 times the height of a spacer specifying the distance between the first and second substrates.

(5) A display device comprising a display panel and liquid crystal lenses arranged on the display panel, wherein the liquid crystal lens includes a liquid crystal of the TN type having a twist angle of 90 degrees, the liquid crystal being sandwiched between a first substrate and a second substrate, a first electrode in a flat shape is formed on the liquid crystal's side of the first substrate to substantially cover the first substrate, second electrodes in a shape like comb teeth in the plan view are formed on the liquid crystal's side of the second substrate, each of the second electrodes is formed on the top of a projection formed on the second substrate, third electrodes extending in the same direction as the second electrodes are formed on parts of the second substrate on both sides of the projection, three-dimensional display is performed by applying voltage between the first and second electrodes and between the first and third electrodes, and two-dimensional display is performed by applying no voltage between the first and second electrodes and between the first and third electrodes.

(6) The display device according to item (5), wherein the same voltage is applied to the second and third electrodes.

(7) The display device according to item (6), wherein the second electrode is formed also on side faces of the projection.

(8) A display device comprising a display panel and liquid crystal lenses arranged on the display panel, wherein the liquid crystal lens includes a liquid crystal of the TN type having a twist angle of 90 degrees, the liquid crystal being sandwiched between a first substrate and a second substrate, projections each having step parts are formed on the second substrate at prescribed pitches, a first electrode in a flat shape is formed on the liquid crystal's side of the first substrate to substantially cover the first substrate, second electrodes in a shape like comb teeth in the plan view are formed on the liquid crystal's side of the second substrate, each of the second electrodes is formed on the tops of the step parts and the each projection having the step parts, three-dimensional display is performed by applying voltage between the first and second electrodes, and two-dimensional display is performed by applying no voltage between the first and second electrodes.

(9) The display device according to item (8), wherein the second electrode is formed also on side faces of the projection having the step parts.

### BRIEF DESCRIPTION OF THE DRAWINGS

FIG. 1 is a cross-sectional view of a liquid crystal lens in a first embodiment of the present invention.

FIG. 2 is a graph showing the transmittance distribution of the liquid crystal lens in the first embodiment of the present invention.

FIG. 3 is a cross-sectional view of a liquid crystal lens in a second embodiment of the present invention.

FIG. 4 is a graph showing the transmittance distribution of the liquid crystal lens in the second embodiment of the present invention.

FIG. 5 is a graph showing the relationship between a gap over a second electrode and the transmittance in a region over the second electrode.

FIG. 6 is a graph showing the relationship between the transmittance in the region over the second electrode and crosstalk.

FIG. 7 is a cross-sectional view of a liquid crystal lens in a third embodiment of the present invention.

FIG. 8A is a plan view showing the second electrodes shown in FIG. 7.

FIG. 8B is a plan view showing the third electrodes shown in FIG. 7.

FIG. 9 is a graph showing the relationship between the width of the third electrode normalized by a cell gap and the correlation value between refractive index distribution and a quadratic curve in the third embodiment.

FIG. 10 is a graph showing the relationship between the width of the third electrode normalized by the cell gap and the crosstalk in the third embodiment.

FIG. 11 is a cross-sectional view of a liquid crystal lens in a fourth embodiment of the present invention.

FIG. 12 is a cross-sectional view for explaining a liquid crystal lens in a fifth embodiment of the present invention.

FIG. 13 is a graph showing an effect achieved in a liquid crystal lens in a sixth embodiment of the present invention.

FIG. 14 is a showing the configuration of a conventional liquid crystal lens.

FIG. 15 is a schematic diagram showing the principle of three-dimensional display employing liquid crystal lenses.

FIG. 16 is a cross-sectional view showing the configuration of a three-dimensional image display device employing a liquid crystal lens.

FIGS. 17A and 17B are plan views showing first and second electrodes of the liquid crystal lens.

FIGS. 18A-18C are cross-sectional views showing examples of the orientation of liquid crystal molecules in a conventional liquid crystal lens.

FIGS. 19A and 19B are cross-sectional views showing the operation of a TN-oriented liquid crystal lens.

FIG. 20 is a schematic diagram showing the operation of a TN-oriented liquid crystal lens when no voltage is applied thereto.

FIG. 21 is a schematic diagram showing the operation of the TN-oriented liquid crystal lens when voltage is applied thereto.

FIGS. 22A and 22B are graphs comparing an ideal transmittance distribution and an actual (conventional) transmittance distribution in a TN-oriented liquid crystal lens.

### DESCRIPTION OF THE PREFERRED EMBODIMENTS

Referring now to the drawings, a description will be given in detail of preferred embodiments in accordance with the present invention. Incidentally, parameters which will be used in the following embodiments are set based on the configuration of the liquid crystal lens created by the present inventors and explained in “SUMMARY OF THE INVENTION”.

### First Embodiment

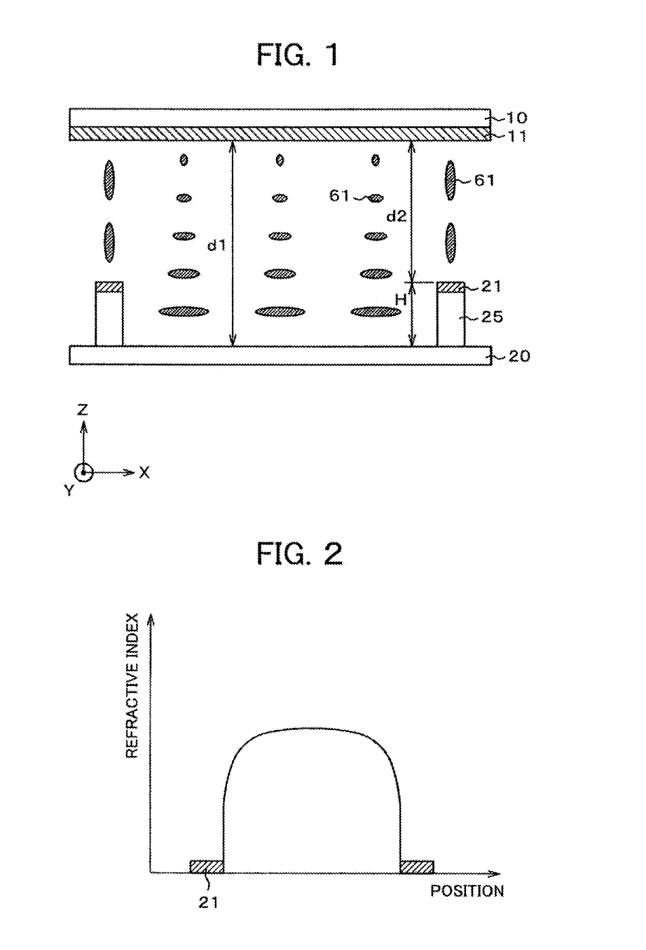

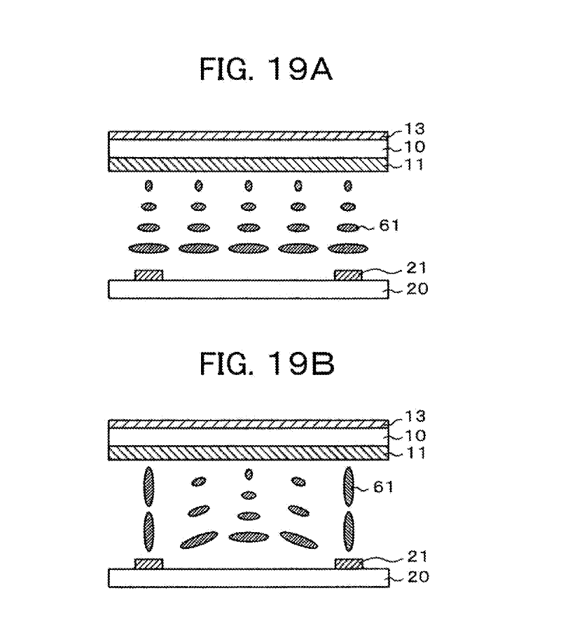

FIG. 1 is a cross-sectional view showing a first embodiment of the present invention. FIG. 1 differs from FIGS. 19A-19B (conventional liquid crystal lens) in that each second electrode 21 is formed on the top of a projection 25 and the distance d2 between the first and second electrodes 11 and 21 is less than the layer thickness d1 of the other parts of the liquid crystal layer 60. The projections 25 can be formed of a material like an organic resist, for example. Both the first and second electrodes 11 and 21 are formed of a transparent material such as ITO (Indium Tin Oxide).

Since the distance between the first and second electrodes 11 and 21 is reduced in FIG. 1 by forming the second electrodes 21 on the projections 25, the electric field generated between the first and second electrodes 11 and 21 is prevented from extending in the in-plane direction. As a result, sufficient light-blocking effect can be achieved in the regions over the second electrodes 21, by which the crosstalk of the TN-orientated liquid crystal lens can be reduced.

FIG. 2 is a graph showing the refractive index distribution of the liquid crystal lens according to this embodiment, wherein the horizontal axis represents the position and the vertical axis represents the refractive index. As shown in FIG. 2, the transmittance decreases to substantially 0 in the vicinity of the second electrodes 21 and sufficient light-blocking effect is achieved. Consequently, the crosstalk of the TN-orientated liquid crystal lens can be reduced. Incidentally, the transmittance distribution in the regions over the second electrodes 21 and/or the transmittance distribution in the region between the second electrodes 21 shown in FIG. 2 can be modified by adjusting the sum H of the height of the projection 25 and the thickness of the second electrode 21 formed on the top of the projection 25, that is, by changing the distance d2 between the first and second electrodes 11 and 21.

### Second Embodiment

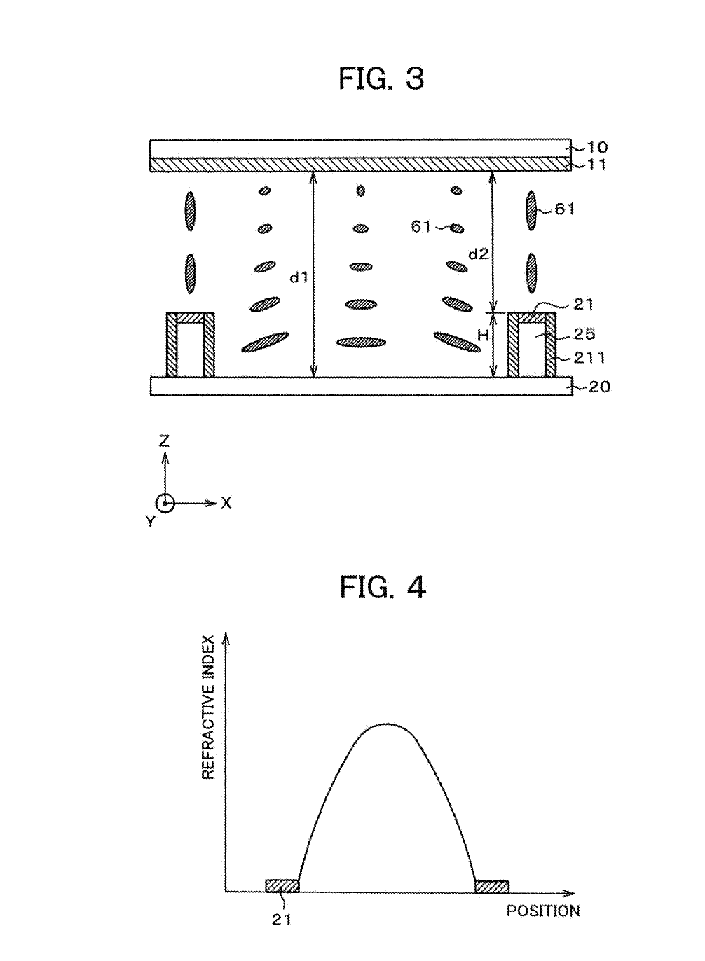

FIG. 3 is a cross-sectional view showing a second embodiment of the present invention. FIG. 3 differs from FIG. 1 in that each second electrode 21 is formed not only on the top of the projection 25 but also on the side faces of the projection 25. The transmittance of the liquid crystal lens is desired to hit the maximum at the central part between adjacent second electrodes 21 and to be 0 over the second electrodes 21. The ideal shape of the refractive index distribution from each second electrode 21 to the central part between second electrodes 21 is a quadratic curve. However, the refractive index distribution between the second electrodes 21 in the configuration of the first embodiment is in a shape deviated from a quadratic curve even though the transmittance is sufficiently low over the second electrodes 21. This is because the lines of electric force from the second electrodes 21 in the first embodiment cannot exert sufficient influence on the formation of the liquid crystal lens.

In this embodiment, each second electrode 21 is formed not only on the top of the projection 25 but also on the side faces of the projection 25 as shown in FIG. 3, by which the lines of electric force from the second electrodes 21 are allowed to exert sufficient influence also on the region between the second electrodes 21. Specifically, the liquid crystal molecules 61 in the vicinity of the second electrodes 21 in FIG. 3 are orientated under the influence of the electric field from the second electrodes 21, achieving orientation closer to a lens shape compared to the orientation of the liquid crystal molecules 61 in the first embodiment.

FIG. 4 is a graph showing the transmittance distribution in the liquid crystal lens of this embodiment shown in FIG. 3. It can be seen in FIG. 4 that the transmittance distribution between the second electrodes 21 is in a shape close to a quadratic curve, that is, a liquid crystal lens of high lens performance has been achieved. Incidentally, the lens shape shown in FIG. 4 can be modified by changing the distance between the first and second electrodes 11 and 21 in FIG. 3.

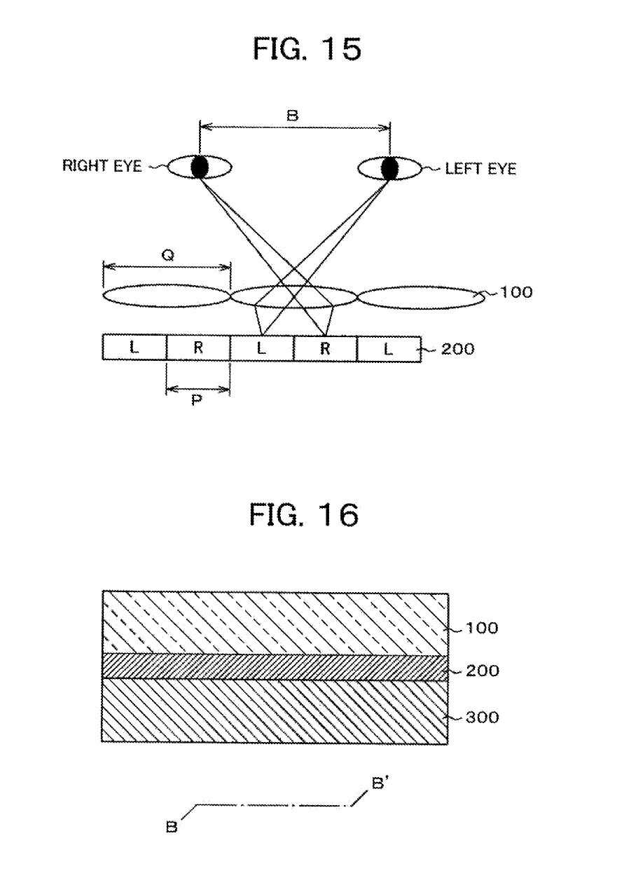

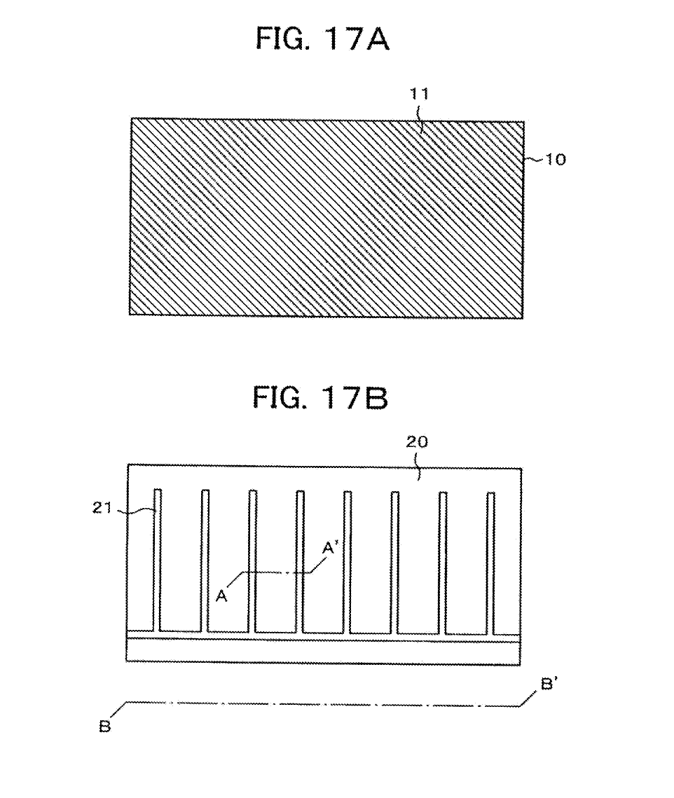

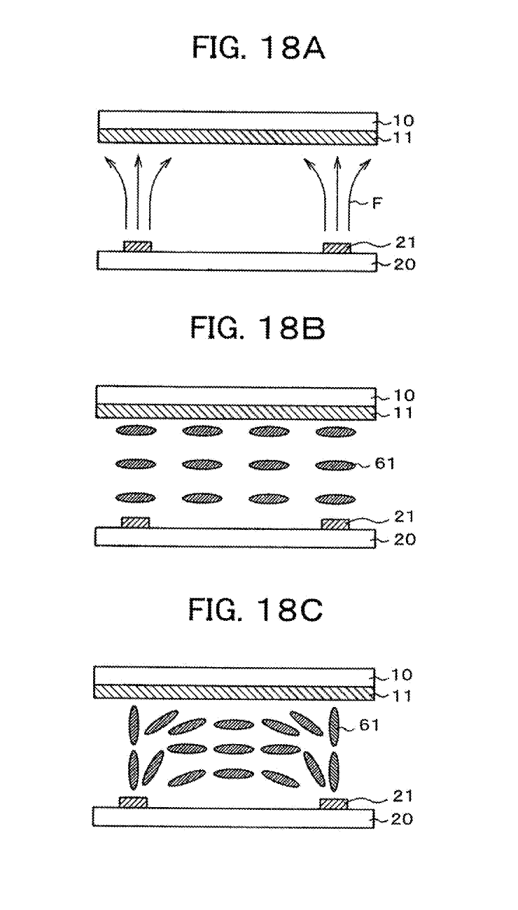

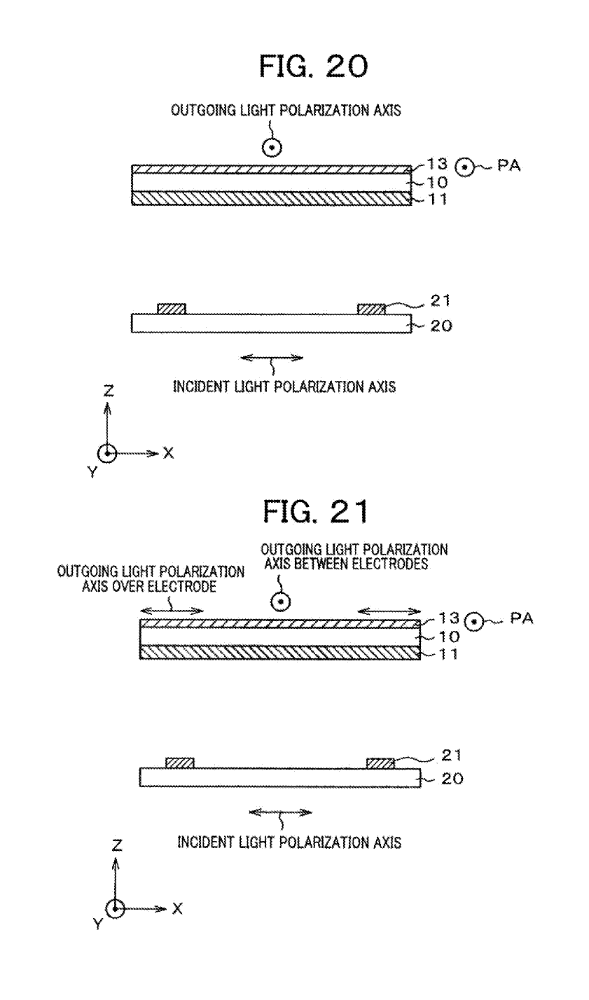

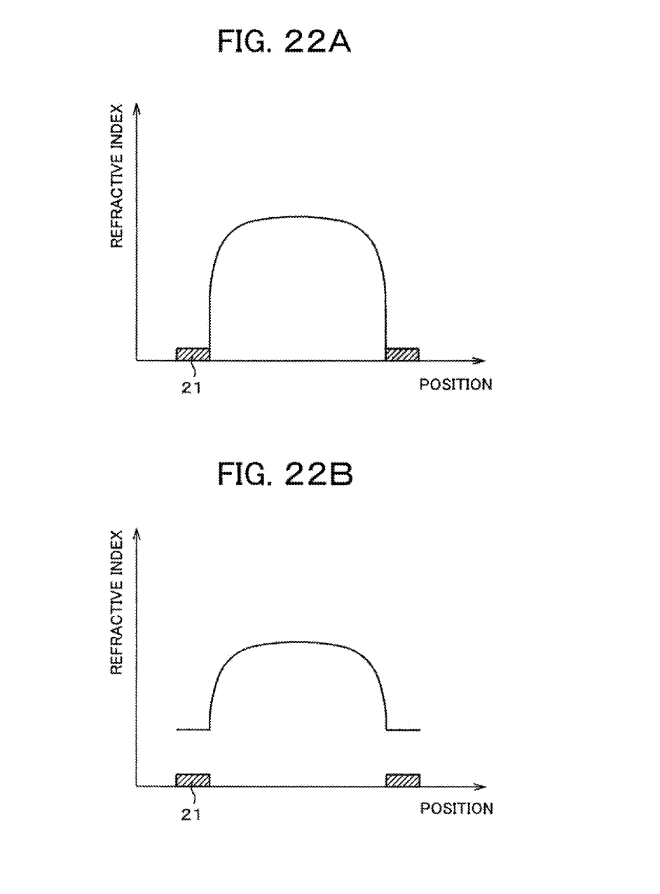

The refractive index distribution will be explained here by using this embodiment. When polarized light oscillating along the incident light polarization axis (X-axis) in FIG. 20 enters the liquid crystal lens, the light is influenced by the refractive index distribution. As a result, the light is condensed as shown in FIG. 15 and the display device is enabled to function as a three-dimensional image display device. The refractive index distribution shown in FIG. 4 is the average of the refractive index (that the polarized light oscillating along the incident light polarization axis (X-axis) and entering the liquid crystal lens undergoes in the process of passing through the liquid crystal lens while rotating toward the outgoing light polarization axis (Y-axis)) taken in the light propagation direction (Z-axis direction).

When the refractive index distribution is in the shape of a quadratic curve, light propagating in the Z-axis direction into the refractive index distribution is condensed and converged on a certain point (focal point). In this case, the display device exhibits the optimum function as the liquid crystal lens-type three-dimensional image display device. Therefore, the refractive index distribution is desired to be in a shape having a high correlation with a quadratic curve. The refractive index distribution of this embodiment (FIG. 4) is closer to a quadratic curve compared to the refractive index distribution of the first embodiment (FIG. 2), and thus exhibits more excellent performance as the liquid crystal lens.

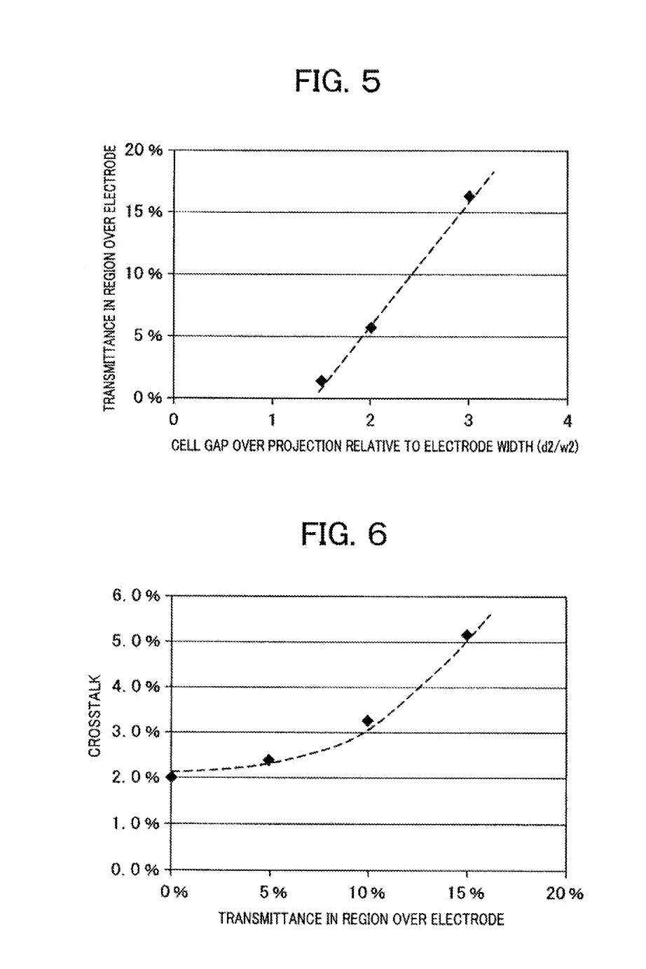

FIG. 5 is a graph showing the relationship between the distance between the first and second electrodes over the projection and the transmittance in the region over the second electrode in this embodiment. In FIG. 5, the horizontal axis represents the distance between the first and second electrodes over the projection relative to the electrode width (d2/w2), while the vertical axis represents the transmittance. Incidentally, the horizontal axis is normalized by the electrode width w2 of the second electrode 21.

The transmittance in the region over the second electrode 21 is a value defined between 0% and 100%. The 100% means that all the light applied to the liquid crystal lens from below passes through the liquid crystal lens. The transmittance in the region over the electrode is 15% when there are no projections and the ratio d2/w2 equals 3. In contrast, the transmittance in the region over the electrode can be reduced to substantially 0% by setting the ratio d2/w2 at 1.5 by forming the second electrodes on projections that are 15 μm high.

FIG. 6 is a graph showing the relationship between the transmittance in the region over the second electrode and the crosstalk in this embodiment. It is clear from FIG. 6 that the crosstalk decreases with the decrease in the transmittance in the region over the second electrode. For the visual recognition of the displayed image as a three-dimensional image, the crosstalk is considered to have to be within 3%. Referring to FIGS. 5 and 6 in combination, the ratio d2/w2 has to be 2.5 or less for this purpose since the transmittance in the region over the second electrode has to be 10% or less in order to achieve the low crosstalk within 3%.

### Third Embodiment

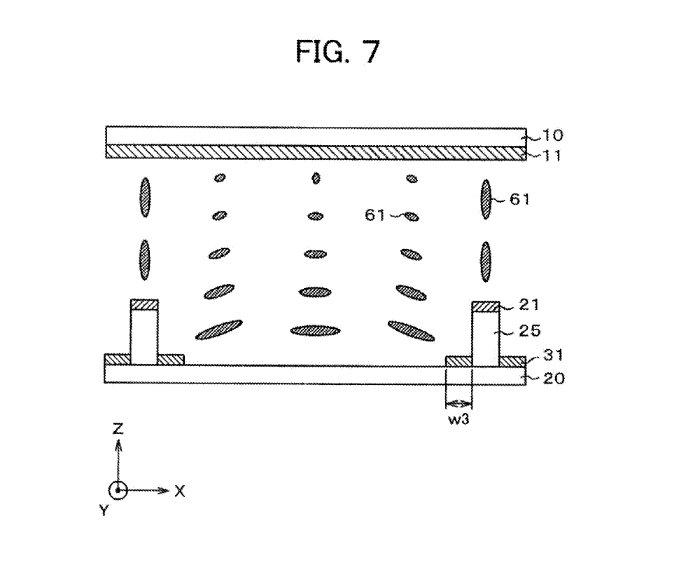

FIG. 7 is a cross-sectional view showing a third embodiment of the present invention. FIG. 7 differs from FIG. 1 (first embodiment) in that third electrodes 31 (width: w3) are formed on parts of the second substrate 20 on both sides of each projection 25 having the second electrode 21 formed thereon. With the configuration shown in FIG. 7, the exertion of the influence of the electric field (for the formation of the lens) on the liquid crystal molecules in the central part of the lens can be facilitated. In cases where the projections 25 are high, the configuration of this embodiment is capable of more efficiently exerting the electric field (for the formation of the lens) on the liquid crystal molecules in the central part of the lens in comparison with the configuration of the second embodiment shown in FIG. 3. Thus, this embodiment is extremely effective in cases where the projections 25 are high.

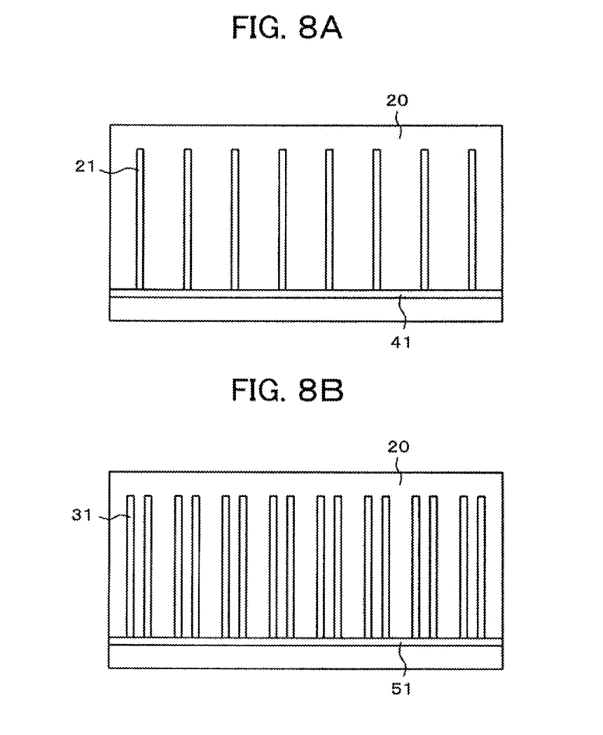

FIG. 8A is a plan view showing the second electrodes 21 formed on the top of the projections 25. In FIG. 8A, the second electrodes 21 formed like the teeth of a comb are connected together at one ends by a fourth electrode 41. The connection of the second electrodes 21 with the fourth electrode 41 is possible by forming the fourth electrode 41 on the second substrate 20 and gradually reducing the height of the projections 25 (like slopes) in the vicinity of the fourth electrode 41, for example.

FIG. 8B is a plan view showing the third electrodes 31 formed on both sides of each projection 25. The third electrodes 31 are formed as pairs each sandwiching each projection 25. The third electrodes 31 are connected together at one ends by a fifth electrode 51.

In this embodiment, the same voltage or different voltages can be applied to the second electrodes 21 and the third electrodes 31 depending on the case. In cases where the same voltage is applied to the second electrodes 21 and the third electrodes 31, the fourth electrode 41 and the fifth electrode 51 can be formed as a common electrode. In cases where different voltages are applied to the second electrodes 21 and the third electrodes 31, the fourth electrode 41 and the fifth electrode 51 have to be electrically insulated from each other for the application of different voltages.

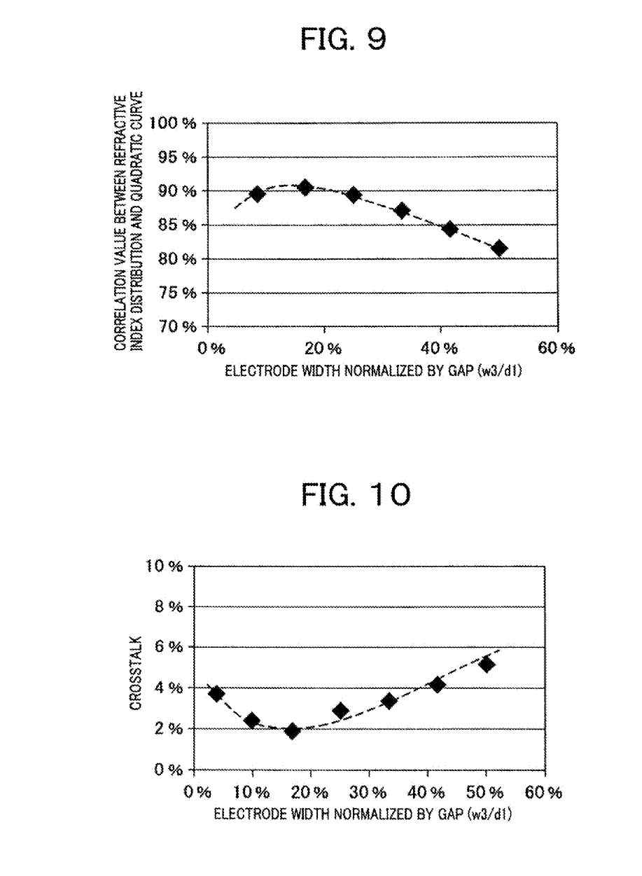

FIG. 9 is a graph showing the relationship between the width w3 of the third electrode 31 (normalized by the distance d1 between the first and third electrodes 11 and 31 (w3/d1)) and the correlation value between the refractive index distribution and a quadratic curve in the case where the second electrodes 21 and the third electrodes 31 are at the same electric potential. The correlation value between the refractive index distribution and a quadratic curve takes on values between 0% and 100%. The 100% means that the refractive index distribution is in the shape of a perfect quadratic curve.

In the three-dimensional image display device employing liquid crystal lenses, the crosstalk decreases when the shape of the refractive index distribution is close to a quadratic curve. Therefore, the crosstalk is expected to decrease as the correlation value between the refractive index distribution and a quadratic curve approaches 100%. The correlation value hits the maximum when the normalized width w3/d1 of the third electrode 31 equals 18% as shown in FIG. 9. Thus, an appropriate electric field distribution has occurred at this point to allow the shape of the refractive index distribution to be the closest to a quadratic curve.

FIG. 10 is a graph showing the relationship between the width w3 of the third electrode 31 (normalized by the distance d1 between the first and third electrodes 11 and 31 (w3/d1)) and the crosstalk in this embodiment. The crosstalk is considered to have to be within 3% for the visual recognition of the displayed image as a three-dimensional image. Thus, the ratio w3/d1 is desired to be within the range 5%≦w3/d1≦25%.

It is also possible in the configuration of FIG. 7 to form the second electrodes 21 also on the side faces of the projections 25. In this case, the electric potential of the third electrodes 31 becomes equivalent to that of the second electrodes 21. Also with such a configuration, a three-dimensional image display device with less crosstalk can be realized.

### Fourth Embodiment

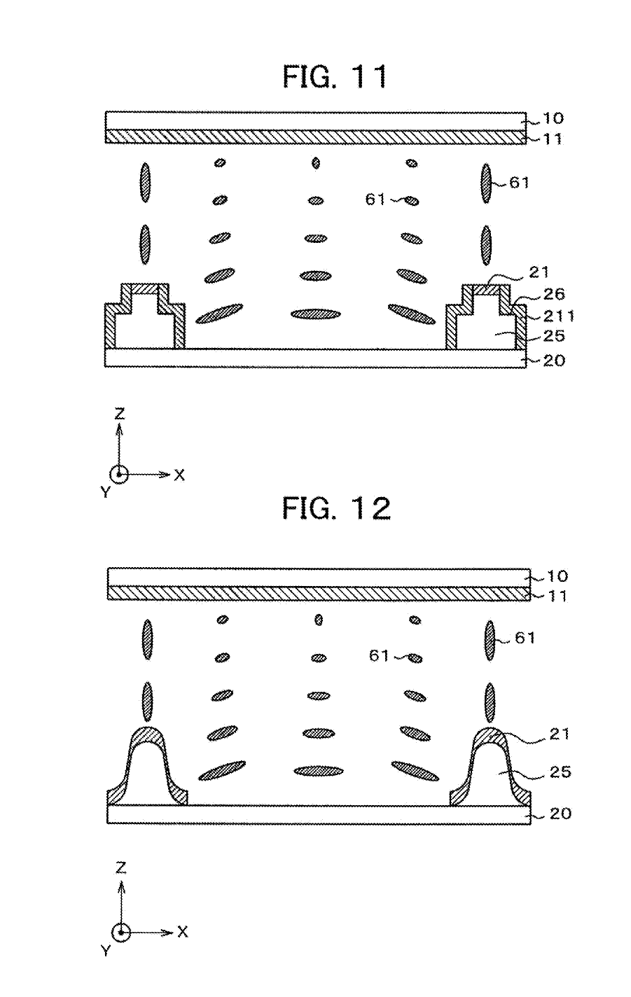

FIG. 11 is a cross-sectional view showing a fourth embodiment of the present invention. The configuration of FIG. 11 is characterized in that the projection 25 is formed to have step parts 26 and the second electrode 21 is formed on the top, the side faces and the step parts of the projection 25. The other configuration is equivalent to that of the first embodiment. In this embodiment, the second electrodes 21 formed on the tops, the side faces and the step parts of the projections 25 are at the same electric potential. Since this embodiment includes the features of both the second and third embodiments, the electric field distribution for the liquid crystal lens can be controlled more precisely. Consequently, the transmittance distribution in the liquid crystal lens can be made closer to a quadratic curve and a three-dimensional image display device with less crosstalk can be realized.

Incidentally, the liquid crystal lens may also be configured by forming the second electrodes 21 only on the tops and the step parts 26 of the projections 25 in FIG. 11, without forming the second electrodes 21 on the side faces of the projections 25. Also with this configuration, a three-dimensional image display device with less crosstalk compared to the first embodiment can be realized.

### Fifth Embodiment

FIG. 12 is a cross-sectional view showing a fifth embodiment of the present invention. The configuration of FIG. 12 is characterized in that the projection 25 has a smooth cross-sectional shape. The other configuration is equivalent to that of the first embodiment. In this embodiment, the second electrode 21 can be formed uniformly on the entire surface of the projection 25 since the cross-sectional shape of the projection 25 is smooth. Also in this embodiment, the transmittance in the region over the second electrode 21 can be set at substantially 0 and the shape of the transmittance distribution between the second electrodes 21 can be made close to a quadratic curve. Consequently, a three-dimensional image display device with less crosstalk can be realized.

### Sixth Embodiment

Also in liquid crystal lenses, a pillar-shaped spacer, spherical beads, or the like is used as a spacer for specifying the distance between the first and second substrates 10 and 20. When there is an impact on the liquid crystal lens in the actual usage environment, such spacers can be broken and it can become impossible to maintain the cell gap of the liquid crystal cell, that is, the distance between the first and second substrates 10 and 20. In contrast, the probability of breakage of the spacers caused by an impact can be reduced if the height of the projections 25 shown in FIG. 1, etc. is set sufficiently high.

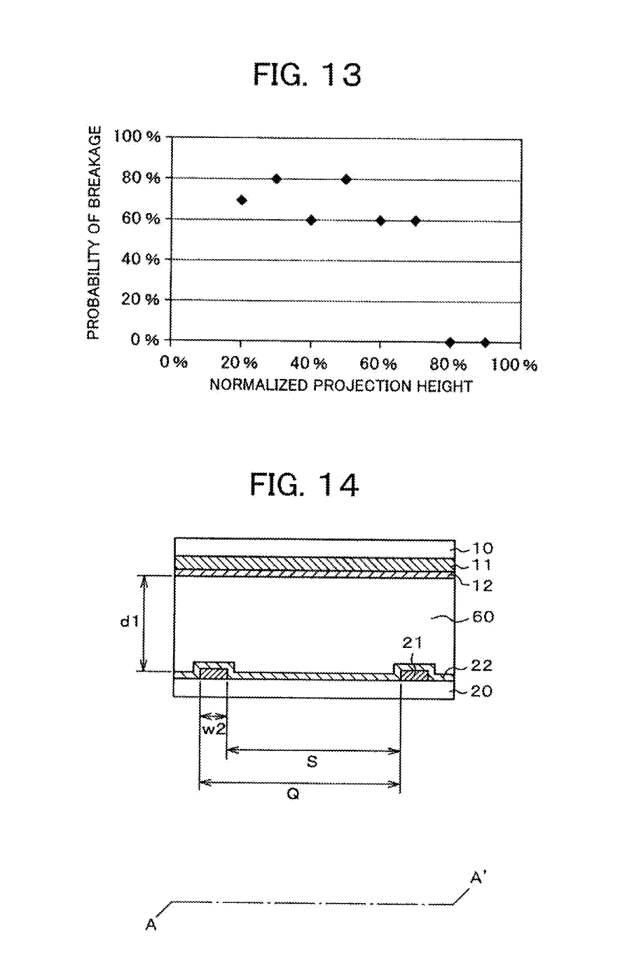

FIG. 13 is a graph showing the relationship between the height of the projections 25 and the probability of breakage of the spacer beads in impact tests. The horizontal axis in FIG. 13 represents the height of the projections 25 normalized by the cell gap. Here, the “cell gap” is synonymous with the height of the spacers. As shown in FIG. 13, the probability of breakage of the spacers drops drastically as the height of the projections 25 reaches 80% of the cell gap. Thus, the breakage of the spacers can be reduced remarkably by setting the height of the projections 25 as H/d1≧0.8 relative to the cell gap d1.

According to this embodiment, the crosstalk of the three-dimensional image display device employing liquid crystal lenses can be suppressed while also preventing the breakage of the spacers for maintaining the cell gaps of the liquid crystal lenses. Consequently, a three-dimensional image display device with less crosstalk and high reliability can be realized.

What is claimed is:

1. A display device comprising a display panel and liquid crystal lenses arranged on the display panel, wherein
the liquid crystal lens includes a liquid crystal of the TN type having a twist angle of 90 degrees, the liquid crystal being sandwiched between a first substrate and a second substrate,
a first electrode in a flat shape is formed on the liquid crystal's side of the first substrate to substantially cover the first substrate,
second electrodes in a shape like comb teeth in the plan view are formed on the liquid crystal's side of the second substrate,
each of the second electrodes is formed on the top of a projection formed on the second substrate,
three-dimensional display is performed by applying voltage between the first and second electrodes, and
two-dimensional display is performed by applying no voltage between the first and second electrodes.

2. The display device according to claim 1, wherein the second electrode formed also on side faces of the projection.

3. The display device according to claim 1, wherein the projection has a cross-sectional shape like a curved line.

4. The display device according to claim 1, wherein the height of the projection is greater than or equal to 0.8 times the height of a spacer specifying the distance between the first and second substrates.

5. A display device comprising a display panel and liquid crystal lenses arranged on the display panel, wherein
the liquid crystal lens includes a liquid crystal of the TN type having a twist angle of 90 degrees, the liquid crystal being sandwiched between a first substrate and a second substrate,
a first electrode in a flat shape is formed on the liquid crystal's side of the first substrate to substantially cover the first substrate,
second electrodes in a shape like comb teeth in the plan view are formed on the liquid crystal's side of the second substrate,
each of the second electrodes is formed on the top of a projection formed on the second substrate,
third electrodes extending in the same direction as the second electrodes are formed on parts of the second substrate on both sides of the projection,
three-dimensional display is performed by applying voltage between the first and second electrodes and between the first and third electrodes, and
two-dimensional display is performed by applying no voltage between the first and second electrodes and between the first and third electrodes.

6. The display device according to claim 5, wherein the same voltage is applied to the second and third electrodes.

7. The display device according to claim 6, wherein the second electrode is formed also on side faces of the projection.

8. A display device comprising a display panel and liquid crystal lenses arranged on the display panel, wherein
the liquid crystal lens includes a liquid crystal of the TN type having a twist angle of 90 degrees, the liquid crystal being sandwiched between a first substrate and a second substrate,
projections each having step parts are formed on the Second substrate at prescribed pitches,
a first electrode in a flat shape is formed on the liquid crystal's side of the first substrate to substantially cover the first substrate,
second electrodes in a shape like comb teeth in the plan view are formed on the liquid crystals side of the second substrate,
each of the second electrodes is formed on the tops of the step parts and the each projection having the step parts,
three-dimensional display is performed by applying voltage between the first and second electrodes, and
two-dimensional display is performed by applying no voltage between the first and second electrodes.

9. The display device according to claim 8, wherein the second electrode is formed also on side faces of the projection having the step parts.
